(19) United States
(12) Patent Application Publication
(10) Pub. No.: US 2005/0122875 A1
(43) Pub. Date: Jun. 9, 2005

(54) Apparatus and method for optical disk drive signal processing

(75) Inventors: Chia-Hua Chou, Hsintien City (TW); Chih-Cheng Chen, Hsin Chu City (TW); Tse-Hsiang Hsu, Hsin Chu City (TW)

Correspondence Address: BIRCH STEWART KOLASCH & BIRCH, PO BOX 747, FALLS CHURCH, VA, 22040-0747, US

(73) Assignee: MEDIA TEK INC.

(21) Appl. No.: 11/000,945

(22) Filed: Dec. 2, 2004

(30) Foreign Application Priority Data
Dec. 5, 2003 (TW) 92134490

(51) Int. Cl. G11B 5/09

(52) U.S. Cl. 369/59.21; 369/47.27

(57) ABSTRACT

The present invention describes an apparatus and method for optical disk drive signal processing. For improving the bandwidth for signal transmitting between an optical disk drive (ODD) controller and an optical pick-up unit (OPU) via a flexible cable, a physical address pre-processing unit is mounted on the optical pick-up unit of a Optical disk drive. The long settling time problem conventionally due to a voltage change in the writing process can be resolved. The apparatus and method extract the physical address in the high-writing process of the Optical disk drive.

### BACKGROUND OF THE INVENTION

1. Field of the Invention

The present invention uses a physical address pre-processing unit mounted on an optical pick-up unit of an optical disk drive to improve the bandwidth of the transmission between an optical disk control unit and the optical pick-up unit, and to extract a physical address in a high-speed writing process.

2. Description of Related Art

The optical disk drive is a standard device for the desktop or the laptop computer. In both the read-only and re-writable type, the read/write speed of optical disk drive is becoming highly and well developed.

Reference is made to FIG. 1, which shows a conventional optical disk drive with a signal processing system. The drive includes an optical pick-up unit 12, an optical disk control unit 14, and a flexible cable 16 therebetween. The optical pick-up unit 12 further includes a laser diode driver 120, laser diode 122, and a photo detector integrated chip (PDIC) 126. Moreover, the optical disk control unit 14 further includes a servo controller 140 and an analog pre-amplifier 142, wherein the analog pre-amplifier 142 includes a physical address generation unit 144.

FIG. 2 shows a schematic drawing of the record layer of an optical disk in tangential direction. The direction 34 is the tangential direction of the optical disk track 32. The laser beam produced by the laser diode 122 is focused on the optical disk record layer 30 of the optical disk track 32.

FIG. 3 shows a detailed structure of the photo detector integrated chip of the prior art. The photo detector integrated chip 126 received the laser beam reflected by the optical disk and transform an optical signal of the laser beam into a plurality of pre-s ample/hold electrical signal. As shown in the schematic drawing, the photo detector integrated chip 126 is divided into four quadrants, A, B, C, and D. In the photo detector integrated chip 126, each of the four quadrants receives the optical signal and transforms the received optical signal into the electrical signals respectively. After that, the electrical signals are transmitted to a gain buffer 42, and generates the pre-sample/hold electrical signals, including a first electrical signal 420, a second electrical signal 422, a third electrical signal 424 and a fourth electrical signal 426. Then the physical address of the optical disk drive can be extracted from the pre-sample/hold electrical signals, and the steps of extraction are described below.

First, generating a determination signal by subtracting the sum of the first electrical signal 420 and the fourth electrical signal 426 from the sum of the second electrical signal 422 and the third electrical signal 424. Next, the determination signal is transmitted to a physical address generation unit 144 of the optical disk control unit 14 for further physical address extraction.

As the schematic drawing shown in FIG. 4, the pre-sample/hold electrical signal from the photo detector integrated chip transforming the laser beam reflected by the optical disk is described. The laser diode 122 writes the information in the optical disk 10 on which a plurality of surface grooves 60 is formed. As the power of laser from the laser diode 122 is written into the grooves, the wave signal of the pre-sample/hold electrical signal shown as a wave pattern 62 in FIG. 4 is unstable.

FIG. 5 shows the wave pattern of a transmitted pre-sample/hold electrical signal, which is the pre-sample/hold electrical signal been transmitted from the photo detector integrated chip 126 to the optical disk control unit 14 via a flexible cable. Corresponding to the surface groove 80 in FIG. 5, the settling time from the peak to the stable state will be stretched, e.g. the curve 51 of the wave pattern 82, after which the zone of S/H will be too narrow to perform sample/hold during the high-speed writing process. Therefore, the erroneous physical address of the track will cause the error decoding.

The block diagram of the physical address generation unit 144 of the optical disk control unit 14 is shown in FIG. 6. There are four pre-sample/hold electrical signals 420, 422, 424 and 426 generated from the photo detector integrated chip shown in FIG. 3. The sample/hold unit 70 receives the four transmitted pre-sample/hold electrical signals 420, 422, 424, 426 and a sample/hold timing 74, and then generates four transmitted post-sample/hold electrical signals 702, 704, 706 and 708. Next, those post-sample/hold electrical signals 702, 704, 706 and 708 are transmitted to a physical address decoding unit 72, and a physical address signal 720 is generated from the physical address decoding unit 72.

The prior method for optical disk drive signal processing comprises the steps described as follows:

The laser beam emitted from the laser diode 122 to optical disk 10 is controlled by the laser diode driver 120 of the optical pick-up unit 12. Subsequently, the laser beam is focused on the optical disk record layer and the optical signals are received by the photo detector integrated chip 126 of the optical pick-up unit 12. The optical signals are then transformed into pre-sample/hold electrical signals via the photo detector integrated chip 126 and the post-sample/hold electrical signals are transmitted to the optical disk control unit 14 through the flexible cable 16. The physical address of the optical disk 10 wherein the laser beam is reflected is generated by the physical address generation unit 144 of the analog pre-amplifier 142 of the optical disk control unit 14, and the physical address is provided to the servo controller 140 for further signal processing.

In the prior art, since the laser power provided by the laser diode 122 makes the pulse modulation with the data to be written to the optical disk 10 when the optical disk drive working in the high-speed writing process, the post-sample/hold electrical signal output from the photo detector integrated chip 126 is also the high-frequency pulse signal as shown in FIG. 4. After that, the high-frequency pulse signal is transmitted to the optical disk control unit 14 via the flexible cable 16, and then the high-frequency pulse signal undergoes sample/hold and decoding in the optical disk control unit 14. However, the flexible cable 16 is not flawless, and interference, including narrow bandwidth and mismatch, prolongs the settling time and mismatches the optical signals. Finally, accuracy and efficiency are difficult to maintain in reading the physical address and recovering the wobble signal as shown in FIG. 5.

For overcoming the physical limitation of the flexible cable, especially when working in high-frequency transmission, the present invention discloses an apparatus for setting a physical address pre-processing unit in the optical pick-up unit and the method thereof for improving the efficiency and accuracy in decoding the physical address of the optical disk.

### SUMMARY OF THE INVENTION

The present invention relates to an apparatus and method for optical disk drive signal processing. A physical address pre-processing unit is installed on an optical pick-up unit for decreasing the bandwidth requirement of a flexible cable and improving the settling time as the voltage changes in the writing process. In implementation, the optical disk drive can perform sample/hold and extract the physical address smoothly.

The apparatus to extract the physical address of the present invention comprises the following elements. An optical pick-up unit includes a laser diode, which emits a laser beam focused on an optical disk record layer. A photo detector integrated chip receives the laser beam reflected from the optical disk and transforms the laser beam into a pre-sample/hold electrical signal. A physical address pre-processing unit is installed in the optical pick-up unit, receives the pre-sample/hold electrical signal and generates an post-sample/hold electrical signal after performing sample/hold. An optical disk control unit includes a physical address generation unit. The post-sample/hold electrical signal is transmitted to the physical address generation unit via a flexible cable to produce the physical address of the optical disk.

The method includes the following steps. A laser beam is emitted from a laser diode and focused on an optical disk record layer of an optical disk. The laser beam is reflected from the optical disk by a photo detector integrated chip and transformed into a plurality of pre-sample/hold electrical signals. The pre-sample/hold electrical signal is received by a physical address pre-processing unit and a post-sample/hold electrical signal is produced after performing sample/hold. The post-sample/hold electrical signal is transmitted to a physical address generation unit of an optical disk control unit via a flexible cable and then becomes a transmitted post-sample/hold electrical signal. Finally, the physical address of the optical disk is produced by a physical address generation unit.

### BRIEF DESCRIPTION OF THE DRAWINGS

The present invention will be readily understood by the following detailed description in conjunction with the accompanying drawings, in which:

FIG. 1 is a schematic drawing of an optical disk control system of the prior art;

FIG. 2 is a schematic drawing of tangential view of a record layer of an optical disk of the prior art;

FIG. 3 shows the inner structure of a photo detector integrated chip of the prior art;

FIG. 4 is a schematic drawing of the wave pattern of the pre-sample/hold electrical signal transformed by the photo detector integrated chip of the prior art;

FIG. 5 is a diagram of the wave pattern of the transmitted pre-sample/hold electrical signal output from a flexible cable of the prior art;

FIG. 6 is a schematic drawing of a physical address generation unit of the prior art;

FIG. 7 is a schematic drawing of an optical disk control system in the present invention;

FIG. 8 is a diagram of the related wave pattern of the present invention;

FIG. 9 is a diagram of the related wave pattern corresponding the FIG. 1 of the prior art; and

FIG. 10 is a flow chart of steps of producing the physical address in the present invention.

### DETAILED DESCRIPTION OF PREFERRED EMBODIMENTS

To allow the Examiner to understand the technology, means and functions adopted in the present invention, reference is made to the following detailed description and attached drawings.

The present invention provides a physical address generation mechanism for optical disk drive signal processing to solve the transmission limitation in high frequency due to the limiting physical property of a flexible cable between an optical pick-up unit and an optical disk control unit. To improve the efficiency and accuracy for extracting a physical address when the optical disk drive working in the high-speed writing process, a physical address pre-processing unit is installed in an optical pick-up unit.

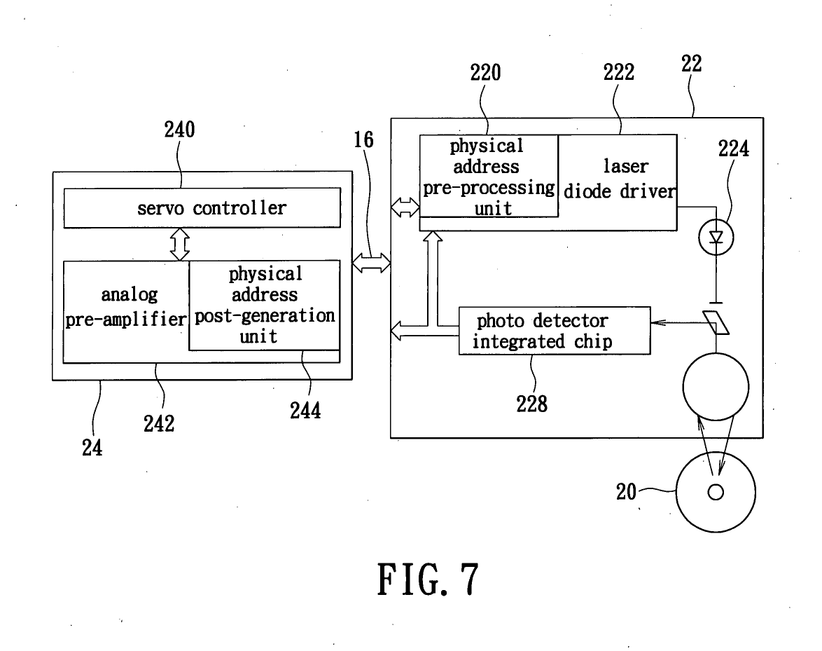

Reference is made to FIG. 7, which is the block diagram of the optical disk drive including an optical disk control unit 24 and an optical pick-up unit (OPU) 22. The optical disk control unit 24 is connected to the optical pick-up unit 22 by a flexible cable 16. The optical pick-up unit 22 includes a laser diode driver (LDD) 222 and a physical address pre-processing unit 220. The physical address pre-processing unit 220 is included in the diode driver (LDD) 222, or alternatively, the physical address pre-processing unit 220 can also be installed outside the laser diode driver 222.

The optical pick-up unit 22 further includes a laser diode 224 and a photo detector integrated chip (PDIC) 228. The optical disk control unit 24 further includes a servo controller 240 for controlling the motion of the optical disk drive, an analog pre-amplifier 242 and the physical address post-generation unit 244, which is used to extract the physical address of the optical disk drive wherein the laser beam is reflected.

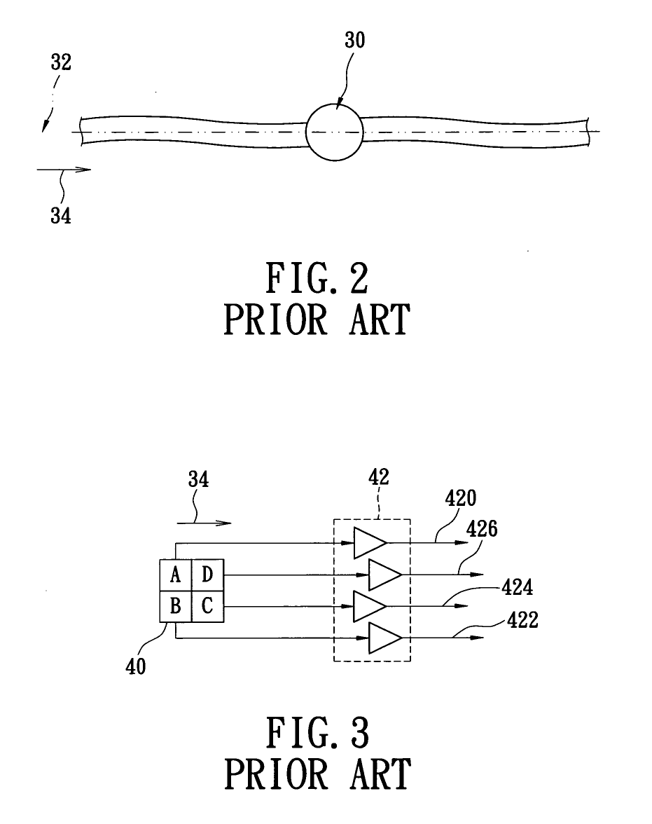

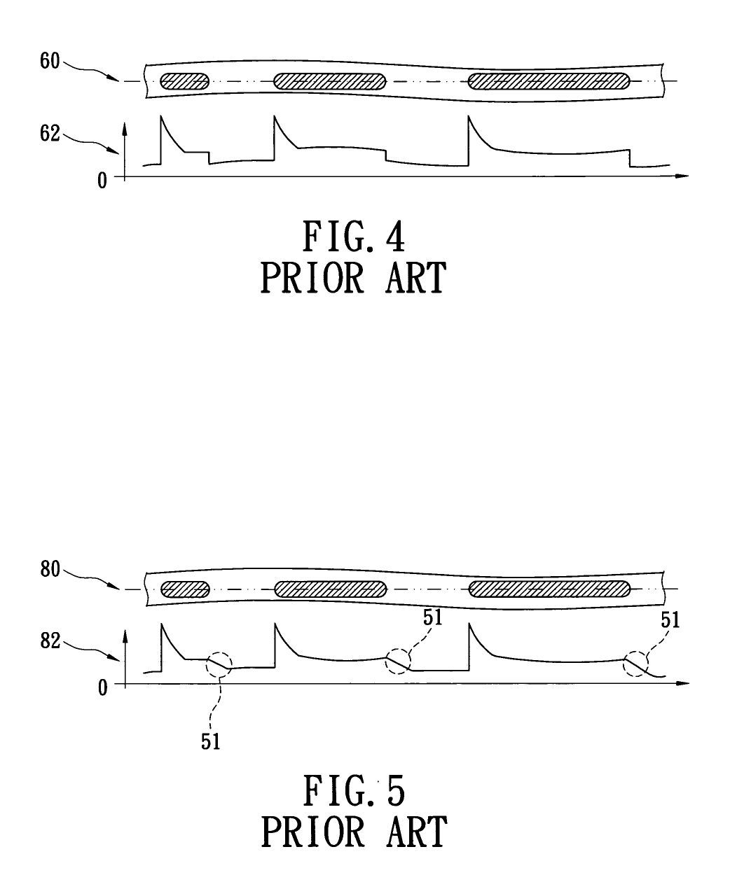

The optical disk drive controlling system described above illustrates that the optical pick-up unit 22 emits a laser beam on an optical disk 20 using the laser diode 224 controlled by the laser diode driver 222. After that, the laser beam is focused on an optical disk record layer (referring to FIG. 2 of the background of the invention), and the reflected laser beam as optical signal is assembled by the photo detector integrated chip 228. After that, the optical signal is transformed into pre-sample/hold electrical signal by the photo detector integrated chip 228. The physical address pre-processing unit 220 receives the pre-sample/hold electrical signal, and samples and holds the pre-sample/hold electrical signal with lower power and cancels the part with high power, and then generates a post-sample/hold electrical signal. The post-sample/hold electrical signal can be sent smoothly from the optical pick-up unit 22 to the optical disk control unit 24 via the flexible cable 16. Then the physical address of the optical disk 20 wherein the reflected laser beam can be extracted using the physical address post-generation unit 244 of the analog pre-amplifier 242. Thus, the extracted physical address is employed for the following signal processing by the servo controller 240 of the optical disk control unit 24.

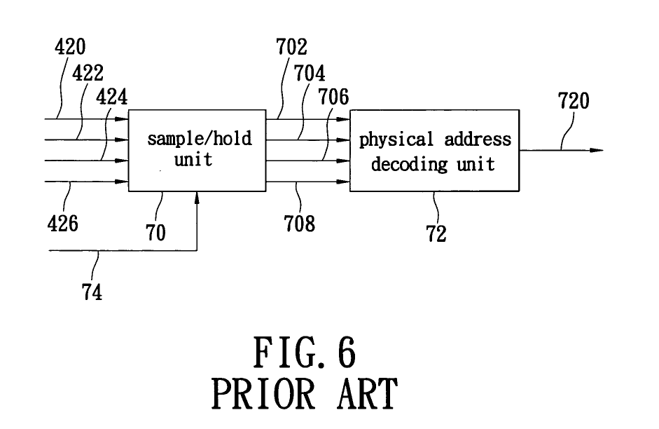

Referring to FIG. 6 of the prior art, the physical address generation unit 144 of the analog pre-amplifier 142 of the optical disk control unit 14 transform the pre-sample/hold electrical signals 420, 422, 424, 426 transmitted from the photo detector integrated chip 126 via the flexible cable 16 into 702, 704, 706, 708 by performing the sample/hold, that is, sampling and holding the pre-sample/hold electrical signals 420, 422, 424, 426 with lower power and canceling the part with high power. However, the present invention perform the sample/hold by using the physical address pre-processing unit 220 which receives the pre-sample/hold electrical signals 420, 422, 424, 426 directly via an internal wire line instead of the flexible line used in the prior art, transforms the pre-sample/hold electrical signals 420, 422, 424, 426 into the post-sample/hold electrical signals 702, 704, 706, 708, and sends the post-sample/hold electrical signals 702, 704, 706, 708 to the physical address post-generation unit 244 via the flexible cable 16. Finally, the physical address signal is extracted by the physical address post-generation unit 244. In addition to a sample/hold unit, the physical address pre-processing unit 220 further includes a combination of a low pass filter, an add-subtract operator and a gain buffer.

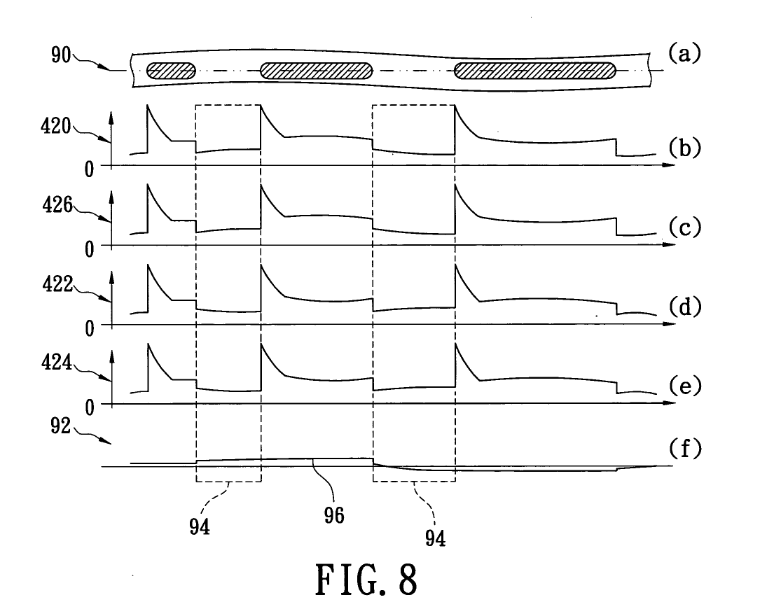

Corresponding to the optical disk groove 90, the curve (b)-(f) in FIG. 8 of the present invention shows the signaling wave pattern of the pre-sample/hold electrical signals and the post-sample/hold electrical signal, the pre-sample/hold electrical signals including the first electrical signal 420, second electrical signal 422, third electrical signal 424, fourth electrical signal 426 and an output signal 92, respectively. After performing the sample/hold on those signals 420, 422, 424, 426, an area with low and smooth waves corresponding to the optical disk groove 90 is selected as a sampling region 94, and the remaining regions, except the sampling regions 94, are selected as the holding region 96. The output signal 92 shown in FIG. 8 is formed after the add-subtract operator, that is: (first electrical signal+fourth electrical signal)−(second electrical signal+third electrical signal). Obviously, the output signal 92 without high-power wave pattern is used for the extraction of the physical address, which is in error when the sample/hold region is too narrow in high frequency of the high-speed operating optical disk.

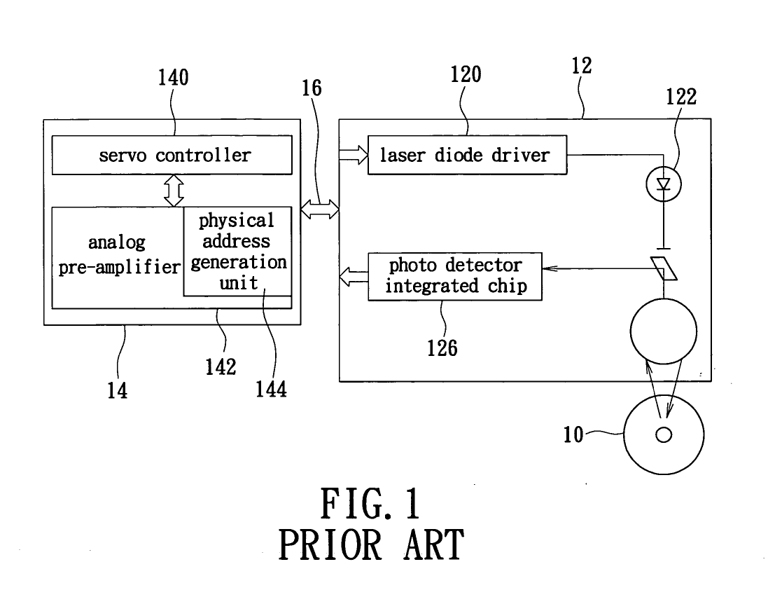

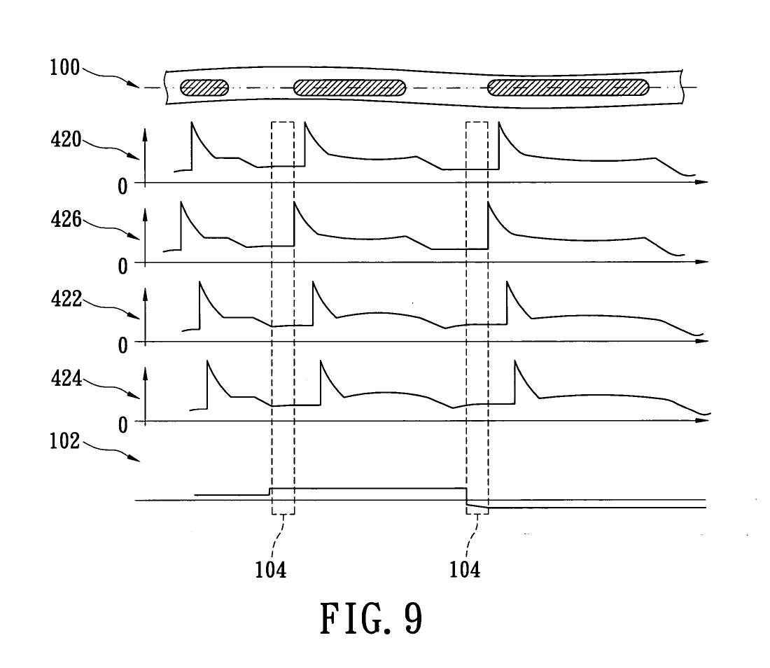

FIG. 9 shows the wave pattern of the transmitted post-sample/hold electrical signal from the optical pick-up unit 22 to the optical disk control unit 24 and the transmitted pre-sample/hold electrical signals corresponding to FIG. 1 of the prior art, wherein the physical address generation unit 244 receives the transmitted pre-sample/hold electrical signals 420, 426, 422 and 424, which all are transmitted via the flexible cable 16. The optical disk groove 100 is the track of an optical disk, and the wave 102 is the output signal after the sample/hold and add-subtract operator. The noise and shifting existing on the four transmitted pre-sample/hold electrical signals 420, 426, 422 and 424 will cause error extraction of the track of the optical disk due to the narrow sampling region 104.

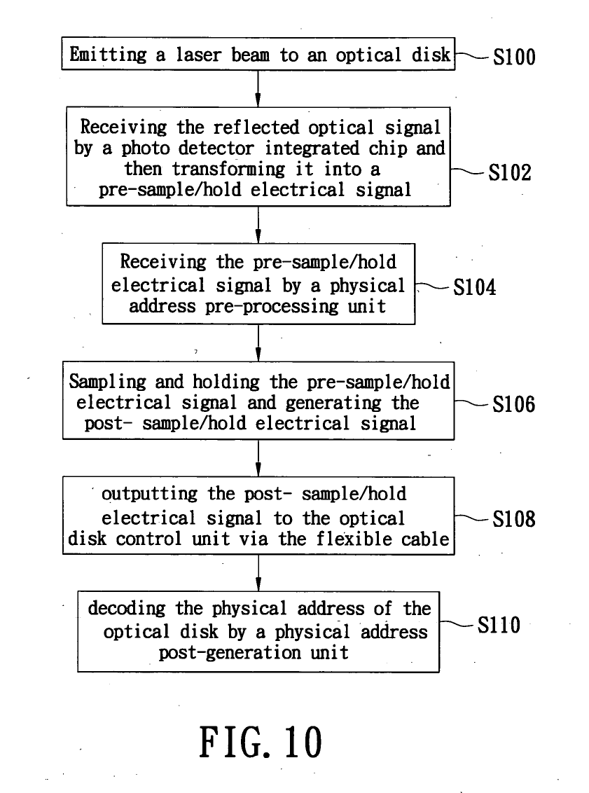

Reference is made to FIG. 10, which illustrates the steps of the method for optical disk drive signaling processing.

First, a laser beam is emitted from a laser diode controlled by a laser diode driver and focused on an optical disk record layer of an optical disk (step S100). A plurality of optical signals reflected from the optical disk is received by a photo detector integrated chip and transformed into a plurality of pre-sample/hold electrical signals (step S102). The pre-sample/hold electrical signals are received by a physical address pre-processing unit of an optical pick-up unit (step S104). An output signal is produced after performing sample/hold, optionally through additional steps including low pass filter, add-subtract operator or gain buffer (step S106). The output signal is transmitted to an optical disk control unit via a flexible cable (step S108). A physical address of the optical disk is extracted by a physical address decoding unit of a physical address post-generation unit (step S110). Finally, the physical address extracted is sent to a servo controller of the optical disk control unit for further processing.

In particular, the present invention relates to an apparatus and method for optical disk drive signal processing, in which a physical address pre-processing unit is installed on an optical pick-up unit for increasing the bandwidth of a flexible cable and avoiding the problematic long settling time when the voltage is changed in writing process. The optical disk drive can then perform sample/hold and extract the physical address smoothly.

The many features and advantages of the present invention are apparent from the written description above and it is intended that the appended claims cover all. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

1. A method used for optical disk drive signal processing to produce a physical address of an optical disk, the method comprising the steps of:
emitting a laser beam and focusing the laser beam on an optical disk record layer of an optical disk;
receiving the laser beam reflected from the optical disk and transforming a optical signal of the laser bean into a plurality of pre-sample/hold electrical signals;
Performing sample/hold to generate a post-sample/hold electrical signal;
transmitting a post-sample/hold electrical signal to a physical address generation unit via a flexible cable; and
extracting the physical address of the optical disk according to the post-sample/hold electrical signal.

2. The method for optical disk drive signal processing as recited in claim 1, wherein the step of performing sample/hold further including a step of low-pass filtering operation.

3. The method for optical disk drive signal processing as recited in claim 1, wherein the step of performing sample/hold further including a step of an adding/subtracting operation.

4. The method for optical disk drive signal processing as recited in claim 1, wherein the step of performing sample/hold further including a step of a buffering operation.

5. An apparatus used for optical disk drive signal processing to produce a physical address of an optical disk, the apparatus comprising:
a laser diode, wherein the laser diode emits a laser beam focused on an optical disk record layer;
a photo detector integrated chip, wherein the photo detector integrated chip receives the laser beam reflected from the optical disk and transforms the laser beam into a plurality of pre-sample/hold electrical signal;
a physical address pre-processing unit, wherein the physical address pre-processing unit receives the a plurality of pre-sample/hold electrical signal and generates a post-sample/hold electrical signal after performing sample/hold;
a physical address post-generation unit, wherein the physical address post-generation unit receives a transmitted post-sample/hold electrical signal and generates the physical address of the optical disk; and
a flexible cable, wherein the post-sample/hold electrical signal generated by the physical address pre-processing unit is transmitted to the physical address generation unit to become the transmitted post-sample/hold electrical signal via the flexible cable.

6. The apparatus for optical disk drive signal processing as recited in claim 5, wherein a low pass filter is added to the physical address pre-processing unit.

7. The apparatus for optical disk drive signal processing as recited in claim 5, wherein an add-subtract operator is added to the physical address pre-processing unit.

8. The apparatus for optical disk drive signal processing as recited in claim 5, wherein a gain buffer is added to the physical address pre-processing unit.
